(19) United States
(12) Patent Application Publication
(10) Pub. No.: US 2015/0262284 A1
(43) Pub. Date: Sep. 17, 2015

(54) Method for Ordering a Product

(71) Applicant: Hungkuang University, Taichung City (TW)

(72) Inventors: Jen-Ya Wang, Taichung City (TW); Tzu-Chi Lo, Taichung City (TW); Yu-Ting Hsieh, Taichung City (TW); Yi-An Chen, Nantou County (TW); Chia-Hui Chien, Taichung City (TW)

(21) Appl. No.: 14/643,124

(22) Filed: Mar. 10, 2015

(30) Foreign Application Priority Data
Mar. 14, 2014 (TW) 103109655

(51) Int. Cl. G06Q 30/06; G06Q 20/20

(52) U.S. Cl. CPC G06Q 30/0635; G06Q 20/202; G06Q 30/0603

(57) ABSTRACT

In a method for ordering a product, a portable electronic device is configured to: obtain catalog information that includes a plurality of product information entries associated respectively with a plurality of products; display an ordering interface on a display screen of the portable electronic device according to the catalog information; upon receipt an order entry which includes a number of a to-be-purchased one of the products through the ordering interface, generating an electronic order that includes the order entry; and allow a point-of-sale (POS) terminal to obtain the electronic order.

### CROSS-REFERENCE TO RELATED APPLICATION

This application claims priority of Taiwanese Application No. 103109655, filed on Mar. 14, 2014.

### FIELD

The disclosure relates to a method for ordering a product with improved efficiency.

### BACKGROUND

When purchasing products in a conventional brick-and-mortar store with cashier-staffed point of sale (POS) terminals, it is not uncommon for a consumer to find himself/herself waiting in line for service (e.g., ordering for food and processing a payment associated with the order). This may be particularly discouraging for the consumer when the waiting time period increases.

Moreover, the ordering of products typically involves a customer verbally reciting the desired product to a staff at the store. It is known that due to potential misunderstanding, verbal communications may not be very accurate and is time-consuming.

### SUMMARY

Therefore, an object of the disclosure is to provide a method that can alleviate at least one of the drawbacks of the prior arts.

According to the disclosure, the method is for ordering a product. The method is to be implemented using a portable electronic device and includes the steps of:

obtaining catalog information that includes a plurality of product information entries associated respectively with a plurality of products;

displaying an ordering interface on a display screen of the portable electronic device according to the catalog information;

upon receipt an order entry which includes a number of a to-be-purchased one of the products through the ordering interface, generating an electronic order that includes the order entry; and

allowing a point-of-sale (POS) terminal to obtain the electronic order.

### BRIEF DESCRIPTION OF THE DRAWINGS

Other features and advantages of the disclosure will become apparent in the following detailed description of the embodiments with reference to the accompanying drawings, of which:

FIG. 1 illustrates a potential environment for implementing an embodiment according to the disclosure;

FIG. 2 illustrates a portable electronic device according to the embodiment;

FIG. 3 illustrates a point-of-sale terminal according to the embodiment;

FIG. 4 illustrates a product catalog displayed on a display screen of the portable electronic device;

FIG. 5 illustrates a specification input interface displayed on the display screen of the portable electronic device;

FIG. 6 illustrates an order entry preview screen displayed on the display screen of the portable electronic device;

FIG. 7 illustrates a checkout screen displayed on the display screen of the portable electronic device;

FIG. 8 illustrates a two-dimensional barcode associated with an electronic order and displayed on the display screen of the portable electronic device; and

FIG. 9 is a flowchart illustrating steps of a method for ordering products, according to the embodiment.

### DETAILED DESCRIPTION

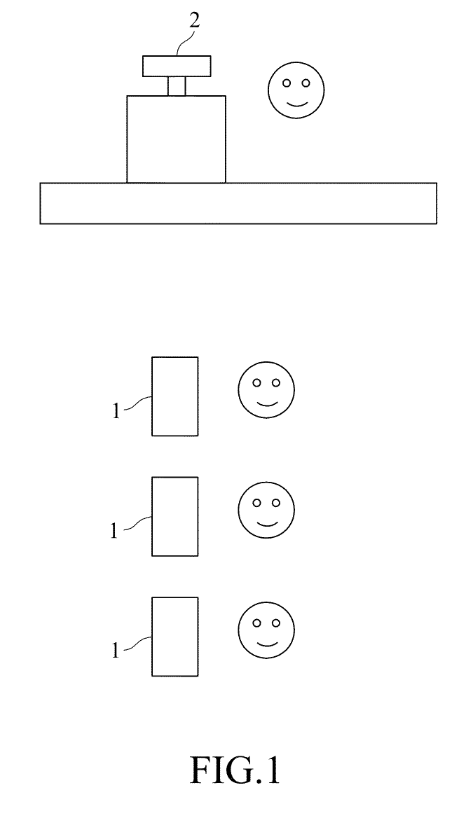

One embodiment according to the disclosure is to be implemented using a portable electronic device 1 that interacts with a point-of-sale (POS) terminal 2. FIG. 1 illustrates a traditional brick-and-mortar store (such as a beverage store), where customers wait in line in front of the POS terminal 2 to be served. The embodiment may be carried out in such an environment.

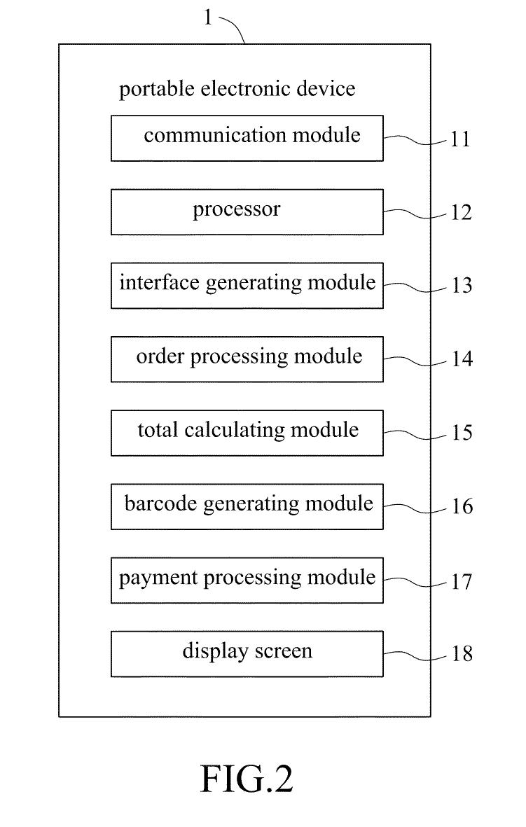

As shown in FIG. 2, the portable electronic device 1 may be embodied using a mobile device, a tablet, a laptop, a personal digital assistant (PDA), etc. The portable electronic device 1 includes a communication module 11, a processor 12 and a display screen 18. The communication module 11 includes a two-dimensional barcode reader that may be embodied using a complementary metal-oxide-semiconductor (CMOS) pixel sensor or a charge-coupled devices (CCD) image sensor.

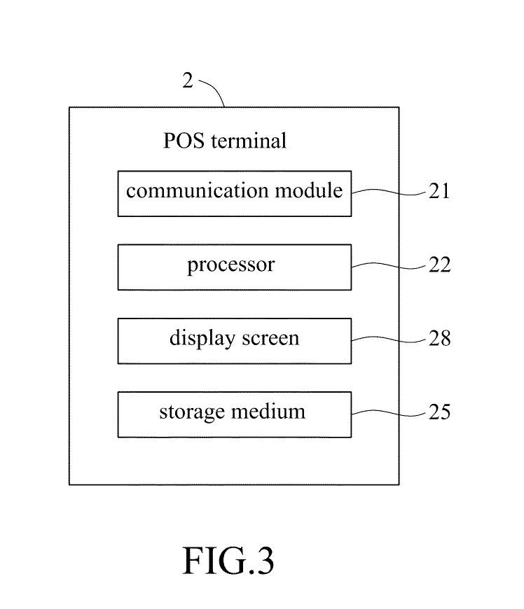

Referring to FIGS. 1 and 3, the POS terminal 2 may be located in a conventional brick-and-mortar store, and includes a communication module 21, a processor 22, a storage medium 25 and a display screen 28. Similarly, the communication module 21 includes a two-dimensional barcode reader.

Before the portable electronic device 1 is able to communicate with the POS terminal 2, the portable electronic device 1 is required to have a particular application installed. The application may be obtained by using the two-dimensional barcode reader to read a two-dimensional barcode that contains a link to the application.

The portable electronic device 1 is operated by a user for obtaining catalog information. The catalog information may be provided by the store and may be downloaded online via a link provided by a two-dimensional barcode. The catalog information includes a plurality of product information entries associated respectively with a plurality of products (e.g., black tea, green tea, etc.). Each of the product information entries includes a sales volume of an associated one of the products. The sales volume indicates a sold quantity of sold ones of the associated one of the products during a predetermined time period.

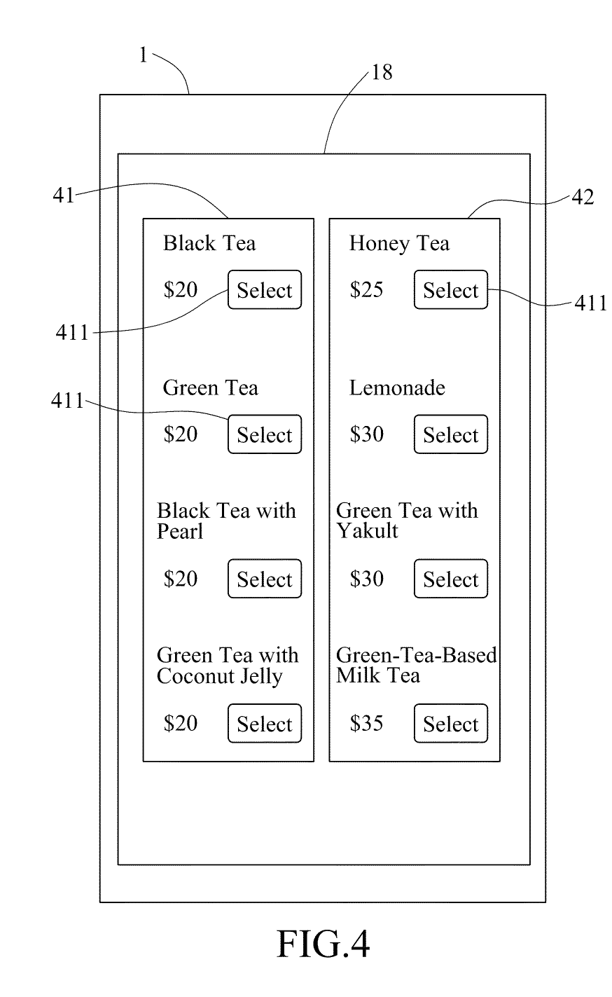

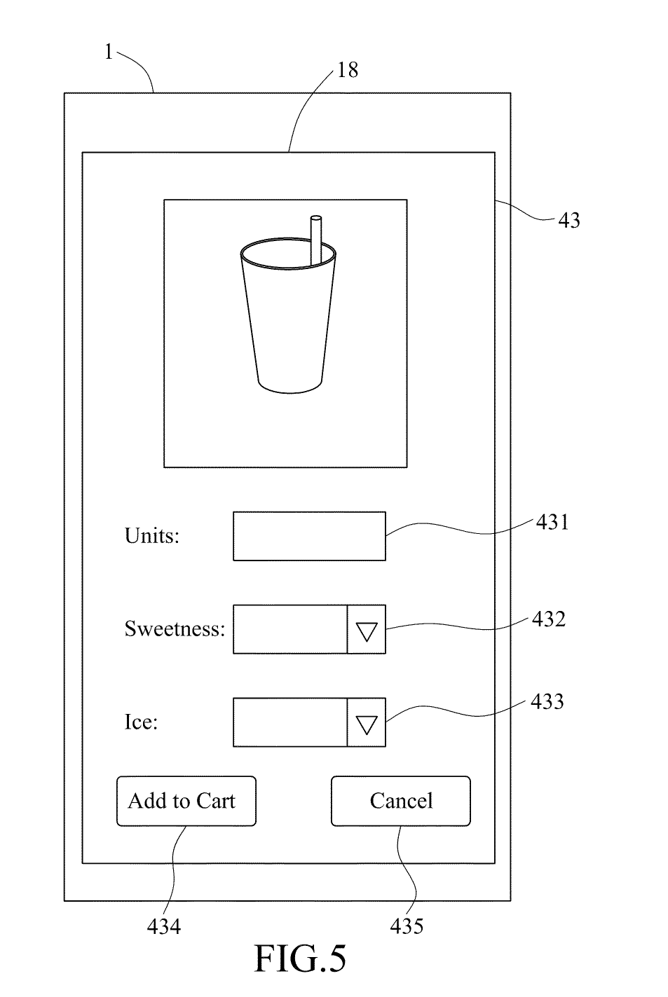

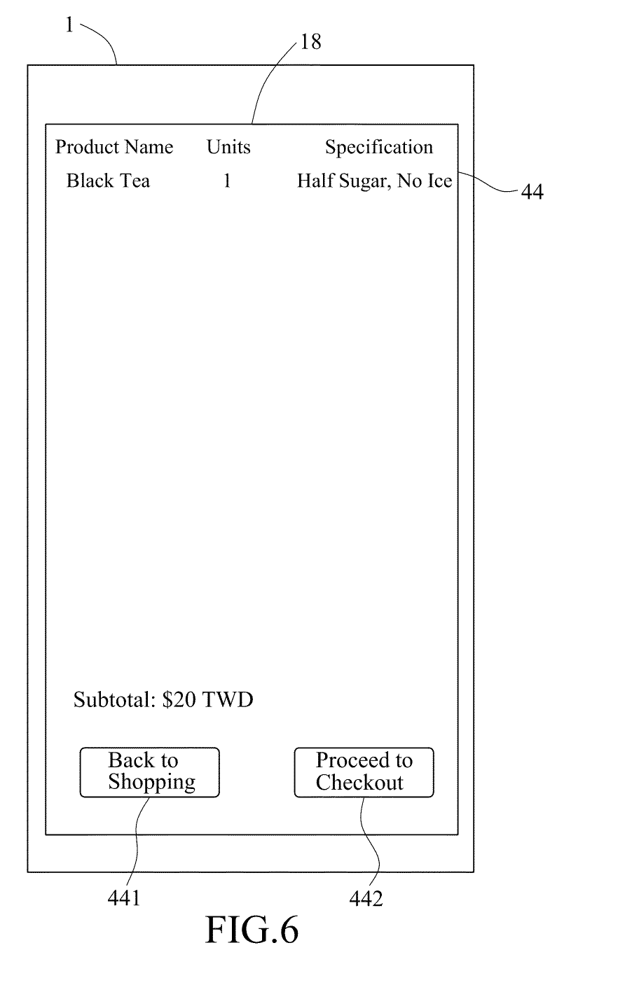

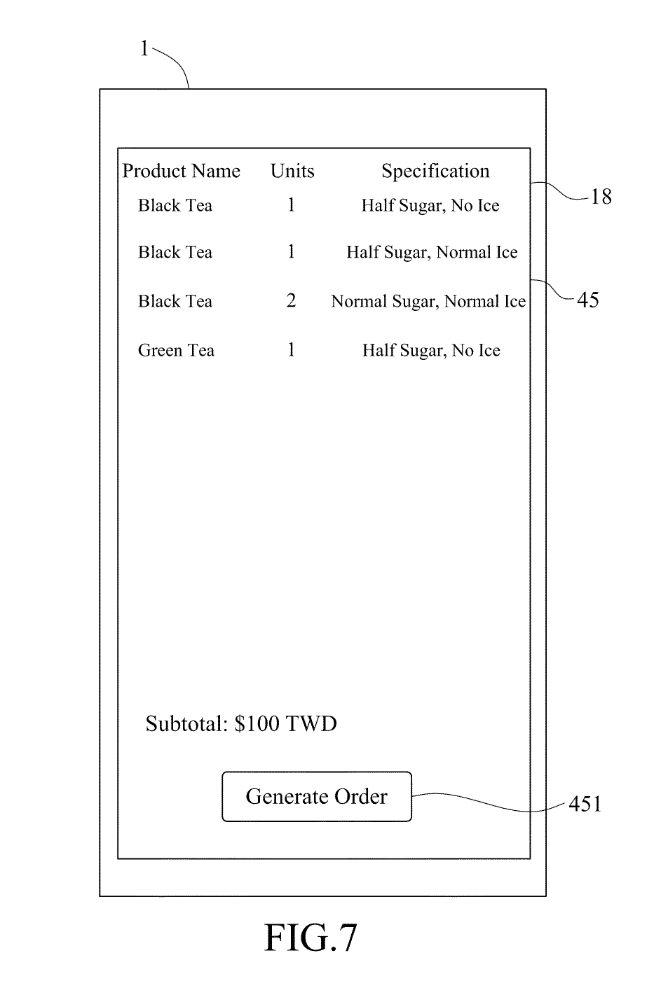

An ordering interface will then be displayed on the display screen 18. In this embodiment, the ordering interface includes a product catalog (see FIG. 4), a specification input interface 43 (see FIG. 5) an order entry preview screen 44 (see FIG. 6) and a checkout screen 45 (see FIG. 7).

In this embodiment, for the sake of emphasizing the products having relatively larger sales volume (also known as the “hot products”), the application is capable of causing the processor 12 to process the plurality of product information entries in order to determine the manner in which the product catalog is to be displayed on the display screen 18. For example, in this embodiment, a display area of the display screen 18 may be divided into a plurality of sub-areas, and one of the sub-areas may be labeled as a hot product area and have the hot products displayed thereon.

To display the product catalog in the aforementioned manner, the portable electronic device 1 performs normalization on the sales volumes respectively of the products. That is, the sales volume of each of the products will be represented as a percentage of a total sales volume covering all products sold during a predetermined time period.

Using the result of the normalization, the portable electronic device 1 determines a sub-group of the products having the normalized sales volumes higher than the normalized sales volumes of others. Specifically, a number of products that is to be included in the sub-group of the products is determined using a data allocation algorithm and according to a size of the display screen 18.

In this embodiment, the data allocation algorithm is a gradient method, as disclosed in Jea, et al., “A Linearly Convergent Method for Broadcast Data Allocation,” Computers & Mathematics with Applications, vol. 56, Issue 2, July, 2008.

In executing the gradient method, a number of parameters will be used as input data: the number of sub-areas to be divided (C); the number of products (N); a database (D) (information contained in the product information entries); and the result of the normalization (L). As a result, the gradient method is capable of obtaining a near-optimal solution according to the abovementioned parameters.

Afterward, the processor 12 divides the display area of the display screen 18 into a plurality of sub-areas, and enables the display screen 18 to display each of the products, in accordance with the product information entry thereof, on a corresponding one of the sub-areas. Allocation of each of the products to the corresponding sub-area is done according to the near-optimal solution of the gradient method.

Referring to FIG. 4, in this embodiment, the display area of the display screen 18 is divided into two sub-areas 41 and 42 to cooperatively display the product catalog, and the sub-area 41 is labeled as the hot product area. On the product catalog interface, for each of the products, there is an associated description (e.g., name, price, or combinations thereof, etc.) and a select button 411, 421 for allowing the user to select the product for purchase.

Specifically, in this example, there are 18 products in the product catalog. According to the near-optimal solution, six of the products are categorized in the sub-group indicating hot products.

It is noted that, in occasions where there is a large number of products in the product catalog, and the listing of the products is too big to fit in the display screen 18 (or the designated sub-area), the product catalog may be displayed on the display screen 18 in such a way that the user needs to scroll up and down in order to locate a desired product.

In this embodiment, by isolating a relatively small percentage of the products as hot products and displaying the hot products in a particular one of the sub-areas, i.e., the sub-area 41, the required area for completely listing the same becomes smaller and it may be relatively easier for the user to find one of the hot products that he/she desires (even if scrolling is still required, the amount of scrolling required to view the entire listing would be relatively shorter). That is to say, a time period that the user may need to spend on finding his/her desired product may be reduced.

After the product catalog is displayed on the display screen 18, the user is able to select one of the products for purchase. In response to the user selection, the processor 12 enables the display screen 18 to display the specification input interface 43 (see FIG. 5) for the user to specify his/her preference (or preferred specification) regarding the selected product. In this embodiment, when the product is a beverage, the specification may include, for example, a number of cups to purchase, sweetness, and amount of ice. When the preference is set, the user may press the “Add to Cart” button for confirmation.

The user input of the “Add to Cart” button is received by the portable electronic device 1 as an order entry. Referring to FIG. 6, the processor 12 enables the display screen 18 to display the order entry preview screen 44 that contains a specification of the order entry (e.g., one cup of black tea, half sugar and with no ice) and a total amount of charge accumulated from the order entry (e.g., $20 TWD). When the user wishes to make more purchase(s), he/she may press the “Back to Shopping” button and will be returned to the product catalog view, i.e., the view with the sub-areas 41 and 42. Otherwise, he/she may press the “Proceed to Checkout” button and will be directed to a checkout screen 45 (see one example in FIG. 7).

In the example in FIG. 7, a total of four order entries are inputted by the user and the total amount of charge accumulated from the order entries is calculated. The user may then press the “Generate Order” button.

In response, the processor 12 is configured to generate an electronic order that includes the order entries. It is noted that, in some embodiments, the processor 12 directly generates the electronic order after the “Proceed to Checkout” button is pressed.

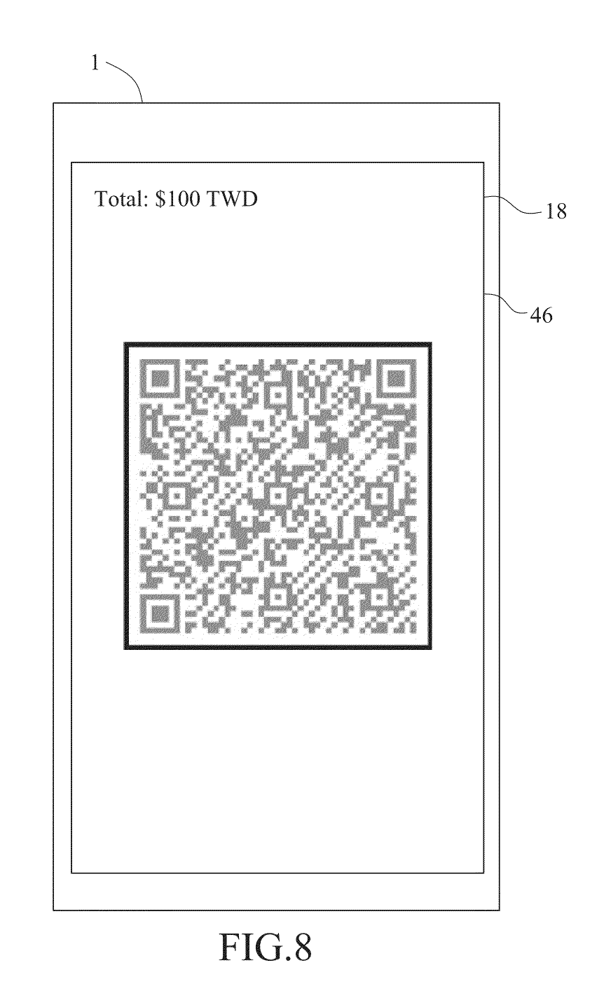

In this embodiment, the processor 12 encodes the order entries in a specific form of text into the electronic order, and converts/encodes the electronic order into a two-dimensional barcode. For example, as shown in FIG. 8, the display screen 18 displays a screen 46 containing a quick response (QR) code that is encoded with the electronic order.

Additionally, in cases that the electronic order includes a large number of order entries, since the two-dimensional barcode is capable of carrying only a limited amount of data, in encoding the order entries the processor 12 may employ some techniques in order to reduce an amount of data of the electronic order.

For example, when a plurality of order entries that are related to the same product but have varying specifications are received, the processor 12 may generate the electronic order by incorporating the varying specifications associated with the same product into a single order entry in the electronic order.

Taking the order entries as shown in FIG. 7 as an example, it is seen that the product “black tea” appears three times, each having a different specification. Without any processing to reduce the amount of data, the generated electronic order may be in the form shown in the following Table 1.

TABLE 1

1 black tea/half sugar/no ice
1 black tea/half sugar/normal ice
2 black tea/normal sugar/normal ice
1 green tea/half sugar/no ice

It is noted that there are four order entries in Table 1. By incorporating the specifications of the first three order entries into a single order entry, the processed electronic order may be in the form shown in the following Table 2, where the number of order entries is reduced to two. The different specifications of the same product are separated by a specific symbol, which is “/” in this example.

TABLE 2

black tea/1 half sugar, no ice/1 half sugar, no ice/
2 normal sugar, normal ice
green tea/1 half sugar, normal ice

Furthermore, it is known that in the QR-code system, a capacity of one QR-code is different for various forms of data. For example, a maximum capacity of a QR-code is 7089 characters for information that includes only numeric symbols and 4296 for information that includes alphanumeric symbols, while for information that includes Kanji/Kana symbols (encoded using Big-5 method), the maximum capacity is 1817 characters. As a result, in cases where non-alphanumeric symbols are used in the order entries, it may be beneficial to further process the order entries to convert the specifications into alphanumeric symbols.

Taking the order entries shown in Table 2 for an example, the product name “black tea” (which is represented by two Kanji/Kana symbols in Chinese) may be encoded as an alphanumeric string “T0001”, and the product name “green tea” may be encoded as an alphanumeric string “T0002”.

A number of units to be purchased is represented in numeric symbols and does not need further processing.

Different levels of sweetness (which is represented by two or three Kanji/Kana symbols in Chinese) may be respectively assigned a single numeric symbol. For example, “non-sugar” may be encoded as the number “0”, “half sugar” may be encoded as the number “2”, and “normal sugar” may be encoded as the number “4”. Similarly, different amounts of ice (which is represented by two or three Kanji/Kana symbols in Chinese) may be respectively assigned a single numeric symbol.

The resulting electronic order may be in the form shown in the following Table 3. Such an electronic order requires a reduced amount of data.

TABLE 3

T0001/1, 2, 0/1, 2, 4/2, 4, 4
T0002/1, 2, 0

With the two-dimension barcode displayed on the display screen 18 of the portable electronic device 1, the user may present the portable electronic device 1 to the staff at the POS terminal 2 to provide his/her electronic order to the POS terminal 2. The communication module 21 of the POS terminal 2 is then used to read the two-dimension barcode. The processor 22 then decodes the two-dimension barcode to obtain the associated electronic order.

It is noted that in some embodiments, the encoding/decoding procedure may be omitted, and the electronic order is transmitted from the portable electronic device 1 to the POS terminal 2 through short-distance wireless communication, which is selected from near field communication (NFC), Bluetooth and radio-frequency identification (RFID).

Subsequently, the processor 22 determines a number of previous order(s) yet to be served prior to the electronic order, and an estimated waiting time period that the user of the portable electronic device 1 may need to wait before the ordered product(s) in the electronic order is (are) ready, based on the electronic order and the previous order(s) yet to be served.

In determining the estimated waiting time period, the processor 22 may use predetermined data stored in the storage medium 25, regarding an average preparing time for each of the products in the electronic order and said previous orders. For example, assume an average preparing time for black tea is T₁, an average preparing time for green tea is T₂, and black tea and green tea are prepared by separate staffs. As a result, a total time period dedicated to preparing the ordered products of the electronic order may be Max (3*T₁, T₂). This total time period is added on top of other time periods for preparing the previous orders to result in the estimated waiting time period.

The number of previous orders yet to be served and the estimated waiting time period will then be displayed on the display screen 28 of the POS terminal 2 to notify the user of the portable electronic device 1 (and all subsequent users waiting in line).

The processor 22 also transmits a paying notification including a total amount of charge associated with the electronic order back to the portable electronic device 1. In response, the portable electronic device 1 initiates a payment with the POS terminal 2. For example, the portable electronic device 1 may have predetermined payment information stored therein, and is able to communicate with the POS terminal 2 (using one of the NFC, Bluetooth and RFID communication techniques) for processing the payment. In other embodiments, the user of the portable electronic device 1 may provide cash to settle the payment.

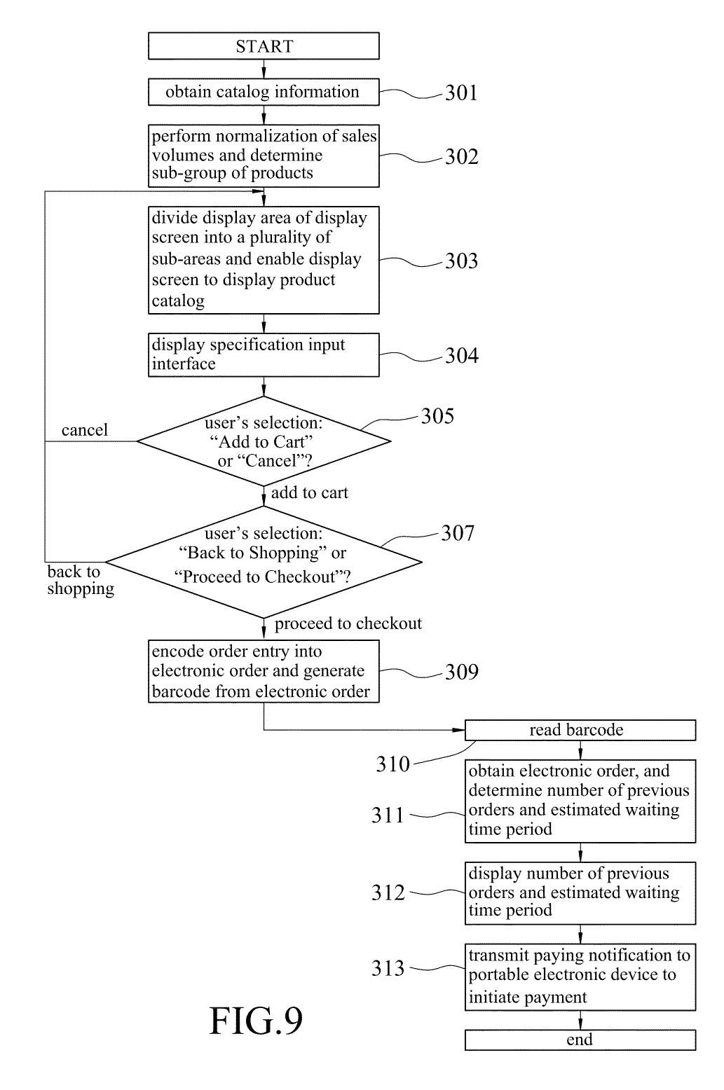

Referring to FIG. 9, when executed by the portable electronic device 1, the application causes the portable electronic device 1 to perform a method for ordering products with the POS terminal 2.

In this embodiment, components of the portable electronic device 1 that executes the application may serve as function-specific modules controlled by the processor 12, namely, an interface generating module 13, an order processing module 14, a total calculating module 15, a barcode generating module 16 and a payment processing module 17.

In step 301, the portable electronic device 1 obtains the catalog information through the communication module 11.

In step 302, the processor 12 performs normalization of the sales volumes respectively of the products, and determines the sub-group of the products.

In step 303, the interface generating module 13 divides the display area of the display screen 18 into a plurality of sub-areas, and enables the display screen 18 to display each of the products, in accordance with the product information entry thereof, on a corresponding one of the sub-areas.

In step 304, in response to the user selecting one of the products, the processor 12 enables the display screen 18 to display the specification input interface (see FIG. 5) for the user to specify his/her preference regarding the product.

Afterward, in step 305, the portable electronic device 1 stands by for the user input instruction. When the user presses the “Cancel” button, the flow goes back to step 303. Otherwise (when the user presses the “Add to Cart” button), the flow proceeds to step 307.

In step 307, the order processing module 14 generates an order entry, and the processor 12 enables the display screen 18 to display the order entry on the order entry preview screen 44 (see FIG. 6). The total calculating module 15 also calculates, in step 307, the total amount of charge accumulated from the order entry.

Then, the portable electronic device 1 stands by for the user input instruction. When the user presses the “Back to Shopping” button, the flow goes back to step 303. Otherwise, (when the user presses the “Proceed to Checkout” button), the flow proceeds to step 309.

In step 309, the order processing module 14 encodes the order entry (or entries) into an electronic order, and the barcode generating module 16 generates a two-dimensional barcode based on the electronic order.

The two-dimensional barcode is then displayed by the display screen 18 to be read by the POS terminal 2 in step 310. In step 311, the processor 22 decodes the two-dimensional barcode to obtain the electronic order, and determines a number of previous order(s) and an estimated waiting time period based on the electronic order and the previous order(s).

In an alternative implementation, in step 309, the two-dimensional barcode is not generated, and the processor 12 transmits the electronic order to the POS terminal 2 through short-distance wireless communication. Note that the purpose of step 309 is to allow the POS terminal 2 to obtain the electronic order.

In step 312, the processor 22 enables the display screen 28 to display the number of previous order(s) and the estimated waiting time period.

In step 313, the POS terminal 2 transmits a paying notification to the portable electronic device 1 to initiate a payment.

To sum up, the disclosure provides a method for ordering a product without the need to verbally recite the product to be ordered, which therefore may be more efficient and accurate. Additionally, the products available for selection by the user and displayed in the product catalog are specifically processed to single out one or more “hot products” which are supposedly more attractive to the user. As a result, the user may be more exposed to the hot products and an amount of time spent for ordering the desired product (s) may be reduced.

Moreover, in generating the electronic order, the order entry/entries may be encoded in a manner as described above, so as to reduce the amount of data required to express the electronic order.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A method for ordering a product, the method to be implemented using a portable electronic device and comprising the steps of:
a) obtaining catalog information that includes a plurality of product information entries associated respectively with a plurality of products;
b) displaying an ordering interface on a display screen of the portable electronic device according to the catalog information;
c) upon receipt of an order entry which includes a number of a to-be-purchased one of the products through the ordering interface, generating an electronic order that includes the order entry; and
d) allowing a point-of-sale (POS) terminal to obtain the electronic order.

2. The method of claim 1, wherein step b) includes the sub-steps of:
dividing a display area of the display screen into a plurality of sub-areas; and
displaying each of the products, in accordance with the product information entry thereof, on a corresponding one of the sub-areas.

3. The method of claim 2, each of the product information entries including a sales volume of an associated one of the products that is sold during a predetermined time period,
the method further comprising, between steps a) and b), the steps of: normalizing the sales volumes respectively of the products; and determining a sub-group of the products according to a size of the display screen and normalized sales volumes of the products, the sub-group of the products having the normalized sales volumes higher than the normalized sales volumes of others;
wherein in the sub-step of displaying each of the products, the sub-group of the products is displayed on one of the sub-areas which is labeled as a hot product area.

4. The method of claim 3, wherein the sub-group of the products is determined using a gradient method.

5. The method of claim 1, further comprising, after step d), the step of:
in response to receipt of a paying notification including a total amount of charges associated with the electronic order from the POS terminal, initiating a payment with the POS terminal.

6. The method of claim 1, wherein, in step d), the electronic order is transmitted to the POS terminal through short-distance wireless communication.

7. The method of claim 6, wherein the short-distance wireless communication is one of near field communication (NFC), Bluetooth and radio-frequency identification (RFID).

8. The method of claim 1, wherein, when a plurality of order entries that are related the same one of the products and that indicate different specifications of the same one of the products are received, step c) is to generate the electronic order by incorporating the different specifications of the same one of the products into a single order entry associated with the same one of the products in the electronic order.

9. The method of claim 8, wherein, in the single order entry, the different specifications are separated by a specific symbol.

10. The method of claim 1, wherein the electronic order is encoded into a two-dimensional barcode, which is to be decoded by the POS terminal in order to obtain the electronic order.

11. The method of claim 10, wherein the two-dimensional barcode is a quick response (QR) code.
